(19) United States
(12) Patent Application Publication
(10) Pub. No.: US 2024/0097966 A1
(43) Pub. Date: Mar. 21, 2024

(54) ON-DEMAND NETWORK INCIDENT GRAPH GENERATION

(71) Applicant: VMware, Inc., Palo Alto, CA (US)

(72) Inventors: Vipul Harsh, Urbana, IL (US); Wenxuan Zhou, Santa Clara, CA (US); Radhika Niranjan Mysore, Cupertino, CA (US); Philip Brighten Godfrey, Champaign, IL (US); Sujata Banerjee, Palo Alto, CA (US)

(21) Appl. No.: 18/094,378

(22) Filed: Jan. 8, 2023

Related U.S. Application Data
(60) Provisional application No. 63/418,296, filed on Oct. 21, 2022.
(60) Provisional application No. 63/408,074, filed on Sep. 19, 2022.

(51) Int. Cl. H04L 41/0631; H04L 41/0604; H04L 43/045

(52) U.S. Cl. CPC H04L 41/0631; H04L 41/0627; H04L 43/045

(57) ABSTRACT

Some embodiments provide a method for evaluating incidents within a network. The method receives notification of a first incident related to a first network entity and a second incident related to a second network entity. In response to the respective notifications of the first and second incidents, the method uses network monitoring data to generate a first component graph of a first portion of the network that includes the first network entity and a second component graph of a second portion of the network that includes the second network entity. The first and second component graphs respectively include first and second sets of network entities related to the first and second network entities according to the network monitoring data. The method uses the first and second component graphs to respectively identify root causes of the first and second incidents.

### BACKGROUND

Modern cloud-based applications have complex interdependencies on both distributed application components as well as network infrastructure, making it difficult to reason about the performance of these applications. Troubleshooting IT incidents relating to these applications, such as slow responsiveness of a service or loss of connectivity, is thus becoming more difficult due to the increasing complexity in the dependencies between application and infrastructure components. Modern microservices-based architectures contribute to the complexity as do the increasingly distributed, disaggregated and virtualized deployments. As a result, when incidents happen, multiple teams, responsible for different infrastructure components, scramble to pinpoint the source of the outage or performance degradation.

Attempts to automate aspects of the troubleshooting workflow have focused on routing incoming tickets to the correct team, orchestrating active probes of availability and/or latency, and localizing faults by inferring the hidden state of components like links silently dropping packets. While attempts have been made to perform more automated root cause analysis, these tools tend to be very limited in generality or accuracy and tend not to do a good job handling dependencies between different components of the network (either mostly ignoring these dependencies or assuming a fixed and known set of dependencies that fails to account for the complexity of modern networks).

### BRIEF SUMMARY

Some embodiments provide a network incident analysis system for evaluating network incidents to identify root causes of those incidents. In some embodiments, upon receiving notification of an incident related to a particular network entity, the network incident analysis system (i) generates a component graph of a portion of the network specific to the incident, (ii) uses the component graph to perform probabilistic analysis that identifies the most likely root causes, and (iii) uses a set of state machines to generate human-readable explanations as to how each root cause could be causing the incident. This network incident analysis system is generalizable to various types of networks (e.g., cloud application deployment, enterprise network infrastructure, etc.) while remaining highly accurate.

The network for which incidents are evaluated may be a multi-tenant cloud datacenter, an on-premises enterprise datacenter, a deployment for a particular enterprise across multiple cloud datacenters, a multi-datacenter network for an enterprise (e.g., an on-premises datacenter as well as multiple branch offices), etc. Within these datacenters, various types of applications are deployed on numerous data compute nodes (e.g., virtual machines, containers) that execute on host computers. These data compute nodes (DCNs) are connected by various network elements (e.g., software virtual switches and routers, top-of-rack (TOR) switches, physical routers, etc.). The network tends to be regularly changing as DCNs are brought up, decommissioned, and/or migrated, applications are scaled up or down, etc.

Because understanding the network environment is important to incident analysis, the network incident analysis tool receives data from various network monitoring tools in some embodiments. The sources of data can include compute and/or network management platforms that monitor the individual host computers and/or network elements, physical network devices (e.g., routers, switches, firewalls, etc.), public cloud provider APIs, NetFlow and/or IPFIX for ongoing data flow information, etc. The data received includes network topology, ongoing flow data, metrics about various network entities (e.g., CPU and/or memory usage for DCNs and hosts, various flow statistics, etc.), metadata for network entities, and other information.

The network incidents, in some embodiments, are incidents either detected by a network monitoring tool or highlighted by a network administrator. Network incidents will often relate to a particular application and/or individual data compute node that is suffering from a problem. For instance, an application might be unable or slow to respond, as reported by a client. In other cases, a specific problematic metric (e.g., a back-end server of an application has high memory and/or CPU usage) is detected by an administrator and/or a network monitoring tool.

As mentioned, upon receiving notification of a network incident (e.g., as specified by a network administrator or detected by an automated process), the network incident analysis system generates a component graph for the incident. In some embodiments, such a component graph includes nodes representing network entities (e.g., application DCNs, physical servers, forwarding elements, flows, etc.), with the edges between these nodes representing relationships between the network entities. Rather than storing (and regularly updating) a component graph for the entire network, the network incident analysis system of some embodiments generates component graphs on-demand to cover only a fraction of the network relevant to the network incident. This provides significant memory savings, as the size of component graphs for entire networks can become extremely large, often including many thousands (or even millions) of interconnected entities that need to be updated regularly as DCNs are brought up, decommissioned, or migrated, flows start and end, etc.

In some embodiments, to generate the component graph, the system begins with any network entities tagged as relating to the incident. For instance, in the common case that the incident relates to a distributed application, any DCNs that are tagged as being part of the application are used to start the component graph. For a three-tier application, this includes the front-end web servers, the application servers, as well as the back-end database servers. For a micro-services-based application (e.g., a Kubernetes application), this can include any of the entities on which these micro-services run (e.g., numerous Kubernetes Pods).

The system then uses defined neighbor relationships to expand the graph outwards from these one or more starting points, adding network entities to the graph. Neighbor relationships can be identified from the monitoring data using various types of relationships. For instance, a VM is neighbors with any flows sent to or from that VM, any of its virtual network interface controllers (VNICs), the host on which the VM executes, virtual disks used by the VM, etc. Host computers are neighbors with the VMs that execute on the hosts, all of their physical NICs, any physical network elements directly connected to the hosts (e.g., TOR switches), etc. After adding all of the neighboring network entities for the initial network entities, the system then adds neighboring network entities for each of these newly added entities, and so on for a defined number of iterations. The number of network entities can grow very quickly (e.g., a host computer might host hundreds of VMs), a VM could have numerous incoming and/or outgoing flows, etc., so the number of iterations may be small (e.g., 3 or 4).

In generating the component graph, the network incident analysis system defines edges between neighboring entities as the network entities are added. In some embodiments, in the absence of specific instructions for a particular type of neighbor relationship, edges are added in both directions between neighboring entities, because dependencies can potentially flow in both directions. For example, the metrics for a VM (e.g., its memory and/or CPU usage) can affect metrics of its host, while the metrics of a host can correspondingly affect the VMs on that host. For certain relationships, the system only defines unidirectional edges (e.g., for caller and callee microservices).

In addition to receiving network topology information that enables building the component graph, the network incident analysis system also receives time series data for various metrics of these entities. As an example, for VMs (and/or host computers on which the VMs run) these metrics can include CPU and/or memory usage, bandwidth, data message drops, disk read/write rate, etc. For data message flows, the metrics can include session count, throughput, round trip time, data message loss, and retransmission rate, among others. Many different types of entities may have many different metrics stored in the network monitoring data.

Some embodiments identify problematic symptoms (metrics) of the relevant network entities. In some embodiments, this is handled as part of the specification of the network incident, with the network administrator identifying one or more metrics of one or more network entities as the incident or indicative of the incident. In other embodiments, the network incident relates to an application or other entity, and the network incident analysis system analyzes any network entities identified as relevant to the incident for problematic symptoms. For instance, if an application has a front-end server and two back-end servers, the analysis might identify any symptoms present at these servers. Other embodiments use tags to identify any network entities that are relevant to the application for which the network incident was identified. To determine problematic symptoms, the network incident analysis system identifies metrics that are above thresholds specified for those metrics. Some embodiments use relatively conservative thresholds when identifying problematic metrics (e.g., 25% CPU, memory, disk, or port utilization, 0.1% drop rate, etc.), or based the thresholds on configured thresholds for receiving alerts. Metrics that surpass (or drop below in certain cases) these thresholds are identified as problematic symptoms for the network entity.

For each problematic symptom, the network incident analysis of some embodiments uses probabilistic analysis based on the component graph for the incident to identify one or more potential root causes of the incident. It should be noted that the potential root cause analysis of some embodiments can use component graphs generated by the network incident analysis tool or other component graphs, but works best with graphs that allow for cyclic dependencies (i.e., as opposed to directed acyclic graphs, which tend to oversimplify dependencies in the network). The network incident analysis system analyzes at least a set of the network entities in the component graph using probabilistic analysis to determine whether adjusting metrics of a given network entity affects the problematic network entity metrics that are diagnosed as indicative of the network incident. If adjustment of the network entity's metrics is determined to affect the problematic entity metrics (and the network entity's metrics themselves at least somewhat deviate from their norm), some embodiments identify that network entity as a potential root cause.

The probabilistic analysis, in some embodiments, uses a Markov Random Field (MRF) framework. Specifically, the network incident analysis system builds a model of the distribution of metrics for all of the entities in the component graph as an MRF. This distribution is defined as a product of individual network entity factors. A function is defined that, for each entity, takes as input the values of the metrics of that entity's incoming neighbors in the directed component graph (i.e., neighbors on which the entity is dependent) and outputs a probability score between 0 and 1.

This probability function is determined by relating metrics of the entity in a time slice to the metrics of its component graph neighbors in the same time slice (e.g., using the network monitoring data collected for the network and provided to the incident analysis system). In some embodiments, the incident analysis system fits a multivariate distribution for the function for all entities using one of a number of different models (e.g., a linear regression with normal error, Gaussian mixture model, a neural network, or a support-vector machine) using historical metric values. Different models are suitable in different environments. Some embodiments select a model by analyzing training errors in learning the probability function across multiple network entities. The data used to train the model is measurement data for the various entity metrics over a specific time period (e.g., the prior week, using a subset of the samples for that week).

Rather than keeping pre-trained models, some embodiments quickly train a model during analysis of each network incident. This ensures that the model is trained for the specific network topology and environment, which changes regularly, so that a model trained for an outdated application topology is not used. Furthermore, the on-demand training ensures that the metric data used for the training is recent and from times relevant to the actual incident. In addition, per-incident training of the models avoids the need to store numerous entity models, thereby saving memory.

With the model built, the incident analysis system can use the model to identify potential root causes of the incident. In some embodiments, the incident analysis system uses the model to adjust metrics of various different selected entities that are one or more hops away from a problematic entity (i.e., an entity relevant to the incident with problematic metric values) in a dependency chain (as determined by the component graph) and determine whether the adjustments have an effect on the problematic entity (i.e., on the problematic metric values of that entity).

Specifically, for a selected entity in the component graph that could potentially be causing the incident, the incident analysis system adjusts the metrics of the entity to a counterfactual value (e.g., dropping the CPU usage, memory usage, and/or network traffic send rate of a VM) that improves upon those metrics. Along the shortest path subgraph of the component graph (i.e., the fewest number of hops in a dependency chain to reach the problematic entity), the model is then used to sample metrics for each successive entity in the subgraph based on the changes to the metrics of the selected entity, until the problematic entity is reached. In some cases, the dependency chain may have multiple equal-length branches. Upon reaching the problematic entity, the metrics of the entities along the dependency chain are resampled for multiple additional iterations in order to account for cyclic dependencies (e.g., a VM and its host having a cyclic dependency of memory and CPU usage). Some embodiments perform this resampling for a predefined number of iterations (e.g., 3 or 4 iterations).

If the adjustment of the metrics for the selected entity has a substantial effect (e.g., a particular number of standard deviations) on the problematic metric(s) of the problematic entity, the incident analysis system identifies the selected entity as a potential root cause. Some embodiments perform this analysis for each of the network entities in the component graph generated for the incident to identify all of the potential root causes. In order to save processing power and time, some embodiments prune entities that do not have any metrics surpassing very conservative thresholds (i.e., more conservative thresholds than those used for identifying problematic entities).

Once the potential root causes for the incident have been identified, the incident analysis system of some embodiments ranks these potential root causes from most likely to least likely. Some embodiments rank the identified network entities based on how anomalous their metrics are. The level of anomaly for a given entity is measured based on the number of standard deviations of its metrics from their historical mean value in some embodiments. Different embodiments use the worst-case metric for each entity or the average level of abnormality for the different metrics of each entity to determine this ranking.

In addition, some embodiments generate human-interpretable explanations as to how each potential root cause may have caused the network incident. For a given potential root cause network entity, the incident analysis system assigns labels to each entity in a dependency chain from the potential root cause entity to the problematic entity based on the metrics of those entities relative to defined thresholds (which may be the same as the thresholds for identifying problematic metrics or different from these thresholds). Examples of these labels can include non-functional, degraded performance (e.g., for a VM or host with high memory or CPU usage, low throughput, high latency, etc.), high drop rate (e.g., for a flow with a high drop rate or a network element that drops a large percentage of data messages it sees), large data flow (or heavy hitter), and properly functional.

Based on these labels, a state machine is applied that encodes causal truths about relations between types of entities assigned different labels. Each node of the state machine is a label and the transitions between these states represent known potential causality (e.g., a heavy hitter flow can cause high drop rate on a virtual NIC or degraded performance of a VM). The state machine is used to trace a path along the dependency chain from the potential root cause to the problematic entity, and the explanation generated by the state machine can be provided to the user to provide a semantically meaningful explanation of how the potential root cause is likely causing the network incident.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and the Drawings is needed. Moreover, the claimed subject matters are not to be limited by the illustrative details in the Summary, Detailed Description, and the Drawings, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purpose of explanation, several embodiments of the invention are set forth in the following figures.

FIG. 1 conceptually illustrates the architecture of a network incident analysis system of some embodiments.

FIG. 2 conceptually illustrates example sources of the network monitoring data for the network incident analysis system.

FIG. 3 conceptually illustrates a process of some embodiments for generating a component graph for an incident that affects a specified network entity.

FIG. 4 conceptually illustrates two stages of the building of a component graph according to some embodiments.

FIG. 5 conceptually illustrates a portion of a network and a portion of a component graph for a network incident that occurs in the network portion.

FIG. 6 conceptually illustrates a process of some embodiments for identifying and ranking root causes for a set of problematic symptoms.

FIG. 7 conceptually illustrates a process for identifying the potential root causes for a given problematic entity.

FIG. 8 conceptually illustrates the pruning of nodes for certain network entities from the analysis of a component graph.

FIG. 9 conceptually illustrates the analysis process to determine whether a selected entity is a likely root cause of a network incident.

FIG. 10 conceptually illustrates a process of some embodiments for generating human-interpretable explanations for a set of root causes.

FIG. 11 conceptually illustrates an example state machine showing transitions between entity labels used to generate explanations for root causes.

FIG. 12 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a network incident analysis system for evaluating network incidents to identify root causes of those incidents. In some embodiments, upon receiving notification of an incident related to a particular network entity, the network incident analysis system (i) generates a component graph of a portion of the network specific to the incident, (ii) uses the component graph to perform probabilistic analysis that identifies the most likely root causes, and (iii) uses a set of state machines to generate human-readable explanations as to how each root cause could be causing the incident. This network incident analysis system is generalizable to various types of networks (e.g., cloud application deployment, enterprise network infrastructure, etc.) while remaining highly accurate.

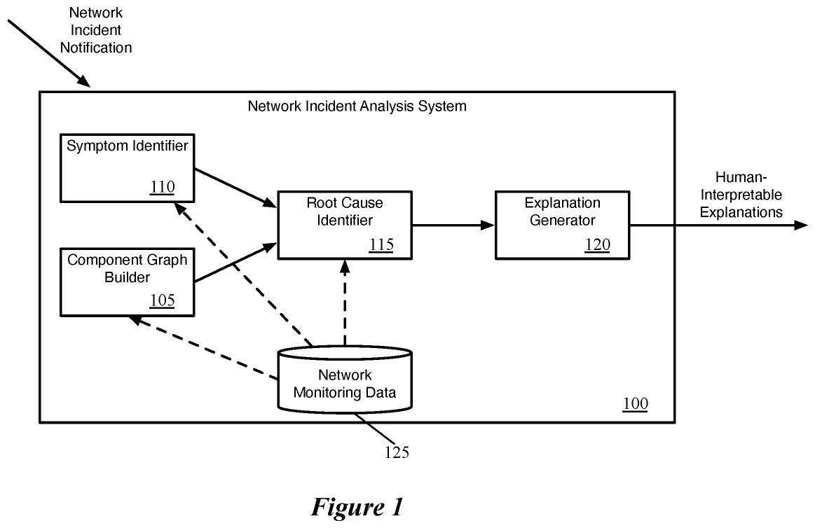

FIG. 1 conceptually illustrates the architecture of a network incident analysis system 100 of some embodiments. The network incident analysis system 100, as shown, includes a component graph builder 105, a symptom identifier 110, a root cause identifier 115, and an explanation generator 120. In different embodiments, the network incident analysis system 100 operates on a single machine (e.g., a single physical computing device, a single virtual machine, etc.) or is distributed across multiple machines. For instance, the incident analysis system 100 is implemented as a cluster of micro-services (e.g., with one or more instance each of the modules 105-120 implemented in a container cluster).

The network for which the incident analysis system 100 evaluates incidents may be a multi-tenant cloud datacenter, an on-premises enterprise datacenter, a deployment for a particular enterprise across multiple cloud datacenters, a multi-datacenter network for an enterprise (e.g., an on-premises datacenter as well as multiple branch offices), etc. In some embodiments, the incident analysis system 100 is deployed on a host or hosts within the datacenter (or one of the datacenters) being monitored. In other embodiments, the system 100 is deployed as a cloud application (e.g., an application as a service) in a separate cloud datacenter or one of the clouds that the monitored network spans.

As shown, the network analysis incident system 100 receives a network incident notification and outputs human-interpretable explanations for potential root causes of the incident. The network incidents, in some embodiments, are incidents either detected by a network monitoring tool or highlighted by a network administrator. Network incidents will often relate to a particular application and/or individual data compute node that is suffering from a problem. For instance, an application might be unable or slow to respond, as reported by a client. In other cases, a specific problematic metric (e.g., a back-end server of an application has high memory and/or CPU usage) is detected by an administrator and/or a network monitoring tool.

Within these datacenters, various types of applications are deployed on numerous data compute nodes (e.g., virtual machines (VMs), containers) that execute on host computers. These data compute nodes (DCNs) are connected by various network elements (e.g., software virtual switches and routers, top-of-rack (TOR) switches, physical routers, etc.). The network tends to be regularly changing as DCNs are brought up, decommissioned, and/or migrated, applications are scaled up or down, etc.

Because understanding the network environment and using current metric data is important to incident analysis, the network incident analysis tool receives data from various network monitoring tools in some embodiments, which is stored in the network monitoring data store 125. In some embodiments, this data store is a database that stores information about hundreds of thousands, if not millions, of network entities. These network entities can include DCNs (e.g., VMs, containers, etc.), host computers, virtual and physical NICs, flows, virtual disks, software and hardware network elements (e.g., TOR switches, spine switches, physical routers, virtual switches and routers, physical and virtual middlebox appliances, etc.), network element interfaces, etc.

For each network entity, the network monitoring data 125 stores multiple performance metrics as time series data in some embodiments, as this data is useful for analyzing network incidents. For example, the network monitoring data 125 could include CPU and memory usage, bandwidth, network traffic rate, packet drops, and disk read/write rate as examples of metrics for VMs (or for host computers). For virtual and/or physical NICs, as well as network element interfaces, examples of metrics include network rate, dropped packets, latency, and interface peak buffer utilization. For data message flows, some embodiments store session count, throughput, round trip time, packet loss, and retransmission ratio as metrics. As mentioned, each metric is stored as a time series of values (e.g., using 1-minute intervals, 5-minute intervals, etc.). Some embodiments aggregate older data (e.g., after 24 hours) into longer intervals (e.g., 30 or 60 minutes) so as to save storage space, and delete the time series data after a period of time (e.g., 30 days).

The network monitoring data 125 also includes metadata for network entities in some embodiments. This metadata can specify certain relationships, such as which physical host each DCN executes on, to which VM a NIC belongs, etc. For flows, the metadata can specify source and destination network addresses or include correlations to DCNs. In addition, various tags can classify DCNs (e.g., associating a DCN with an application, an application tier, etc.).

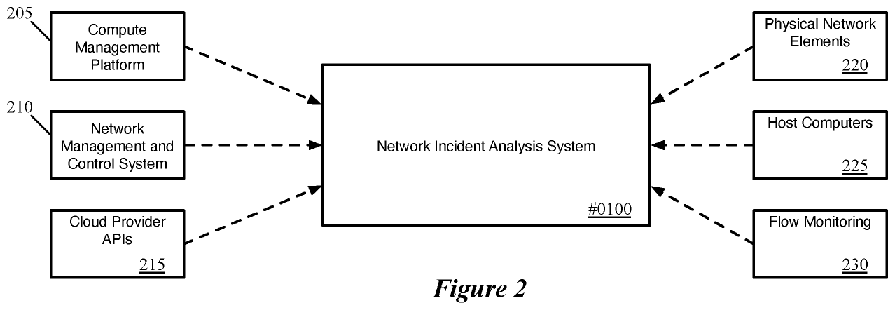

FIG. 2 conceptually illustrates example sources of the network monitoring data for the network incident analysis system 100. As shown, the network monitoring data can be received from (among other data sources) compute management platforms 205 that manage the life cycle of DCNs across one or more datacenters as well as network management and control systems 210 that manage the network infrastructure for a datacenter or multiple datacenters (including deployments of virtual datacenters in a cloud). These network management and control systems 210 can include SD-WAN controllers, Kubernetes controllers, on-prem network management platforms, etc. In addition, if the network being monitored extends to (or is entirely within) one or more public clouds, then the network incident analysis system 100 uses cloud provider APIs 215 to retrieve information from these public clouds. The network monitoring data also includes information collected directly from the network infrastructure, including data from physical network elements 220 (e.g., routers, switches, firewalls, etc.) and host computers 225. The network incident analysis system 100 also receives flow data (e.g., for ongoing data flows) via flow monitoring 230. This information can be collected directly via IPFIX and/or NetFlow, as well as from a network monitoring application that collects and synthesizes flow information from host computers, such as that described in U.S. Pat. No. 11,398,987, which is incorporated herein by reference.

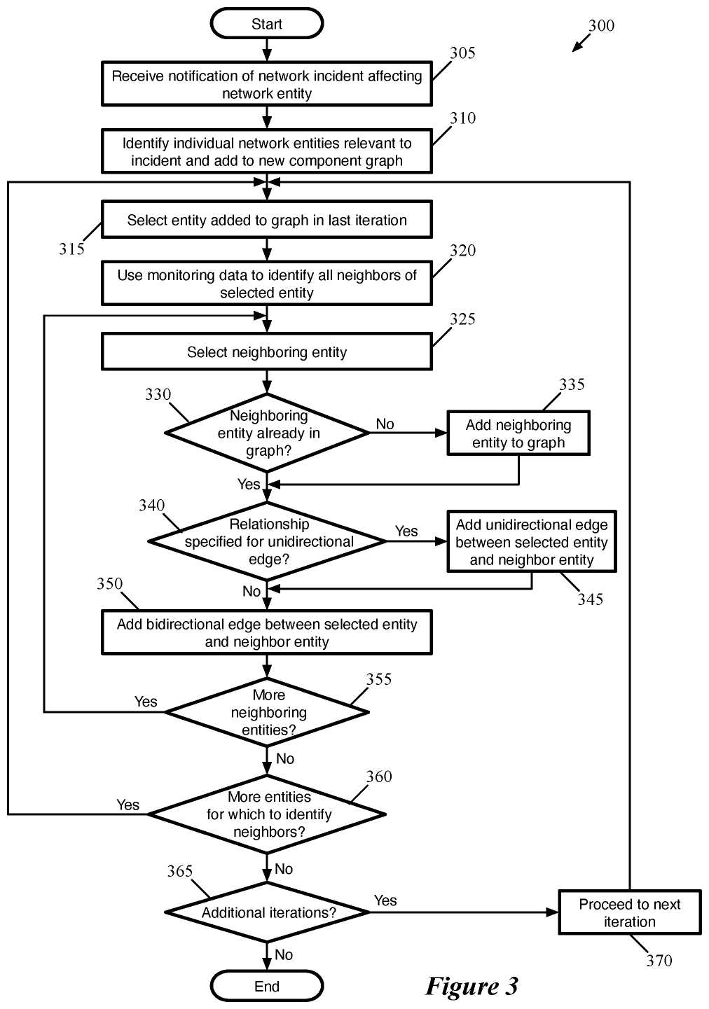

Returning to FIG. 1, the component graph builder 105, which will be described in greater detail below by reference to FIGS. 3-5, generates a component graph on-demand for the incident. In some embodiments, such a component graph includes nodes representing network entities (e.g., application DCNs, physical servers, forwarding elements, flows, etc.), with the edges between these nodes representing relationships between the network entities. Rather than storing (and regularly updating) a component graph for the entire network, the component graph builder 105 of some embodiments generates component graphs on-demand to cover only a fraction of the network relevant to the network incident. This provides significant memory savings, as the size of component graphs for entire networks can become extremely large, often including many thousands (or even millions) of interconnected entities that need to be updated regularly as DCNs are brought up, decommissioned, or migrated, flows start and end, etc. The component graph builder 105 uses network monitoring data 125 (e.g., the relationships specified by network entity metadata) to build the component graph for the incident by identifying neighbor relationships. These component graphs, which are used for root cause identification in some embodiments, can (and typically do) include cyclic dependencies.

The symptom identifier 110, in some embodiments, identifies problematic symptoms (metrics) of network entities relevant to the network incident. In some embodiments, this is handled as part of the specification of the network incident, with the network administrator identifying one or more metrics of one or more network entities as the incident or indicative of the incident (e.g., specifying that back-end VMs of an application have high CPU and/or memory usage, or are dropping too many data packets).

In other embodiments, the network incident notification simply specifies an application or other network entity, and the symptom identifier 110 analyzes any network entities identified as relevant to the incident for problematic symptoms. For instance, if an application has a front-end server and two back-end servers, the symptom identifier 110 might identify any symptoms present at these servers. Some embodiments use tags in the network monitoring data to identify any network entities that are relevant to the application for which the network incident was identified. To determine problematic symptoms, the network incident analysis system identifies metrics that are above thresholds specified for those metrics. Some embodiments use relatively conservative thresholds when identifying problematic metrics (e.g., 25% CPU, memory, disk, or port utilization, 0.1% drop rate, etc.), or based the thresholds on configured thresholds for receiving alerts. Metrics that surpass (or drop below in certain cases) these thresholds are identified as problematic symptoms for the network entity.

For each problematic symptom, the root cause identifier 115 of some embodiments uses probabilistic analysis based on the component graph for the incident to identify one or more potential root causes of the incident. It should be noted that the potential root cause analysis of some embodiments can use component graphs generated by the component graph builder 105 or other component graphs, but works best with graphs that allow for cyclic dependencies (i.e., as opposed to directed acyclic graphs, which tend to oversimplify dependencies in the network). That is, the root cause analysis performed by the root cause identifier 115 is not limited to operating within a system that generates its own component graphs.

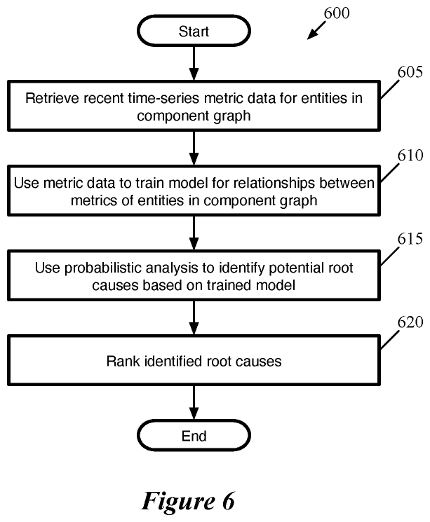

In some embodiments, the root cause identifier 115 builds a model (e.g., using machine learning based on the time series metric data for the network entities in the graph) that correlates metrics of different entities in the component graph with each other. For each problematic entity (i.e., network entity identified as having problematic symptoms indicative of the network incident, the root cause identifier 115 then probabilistically analyzes at least a set of the network entities in the component graph using the model to determine whether adjusting metrics of a given network entity tends to affect the problematic network entity metrics. If adjustment of the network entity's metrics tends to affect the problematic entity metrics (and the network entity's metrics themselves at least somewhat deviate from their norm), some embodiments identify that network entity as a potential root cause of the network incident. The root cause identification process will be described in greater detail below by reference to FIGS. 6-9.

The explanation generator 120 of some embodiments generates human-interpretable explanations as to how each potential root cause is likely to have caused the network incident. For a given potential root cause network entity, explanation generator 120 assigns labels to each entity in a dependency chain from the potential root cause entity to the problematic entity based on the metrics of those entities relative to defined thresholds (which may be the same as the thresholds for identifying problematic metrics or different from these thresholds). Based on these labels, the explanation generator 120 applies a state machine that encodes causal truths about relations between types of entities assigned different labels to generate an explanation that is provided to the user (e.g., a network administrator) to provide a semantically meaningful explanation of how the potential root cause is likely causing the network incident.

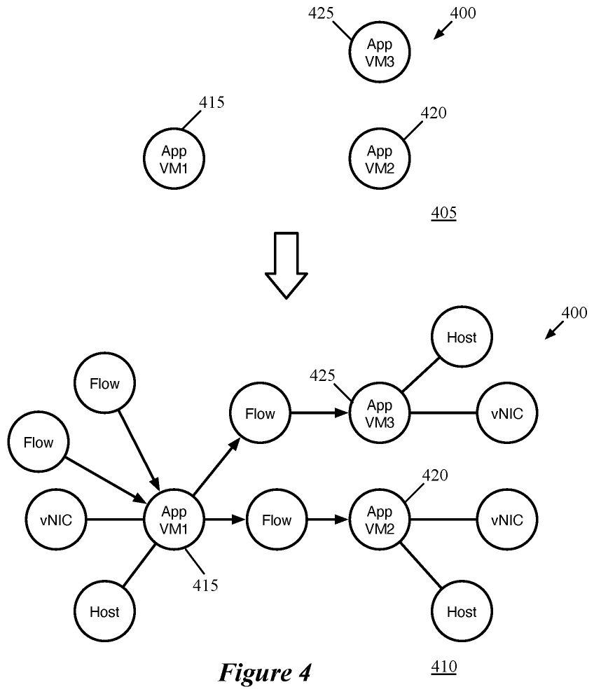

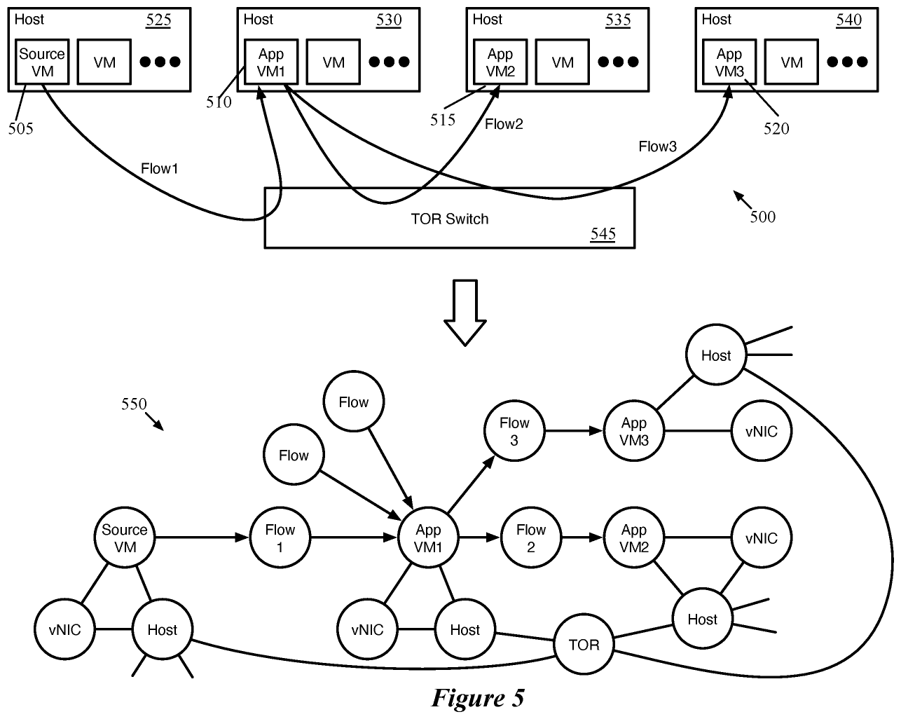

As mentioned, upon receiving notification of a network incident (e.g., as specified by a network administrator or detected by an automated process), the network incident analysis system of some embodiments generates a component graph for the incident. FIG. 3 conceptually illustrates a process 300 of some embodiments for generating a component graph for an incident that affects a specified network entity. The process 300 is performed by a network incident analysis system, and specifically by a component graph builder module of such a system in some embodiments. The process 300 will be described at least in part by reference to FIGS. 4 and 5, which illustrate examples of component graphs being built.

As shown, the process 300 begins by receiving (at 305) a notification of a network incident affecting a network entity. In some embodiments, the notification simply specifies a distributed application or other generalized network entity, rather than a specific VM, container, etc. For instance, if a distributed application is responding slowly, this might be reported to a network administrator as a trouble ticket, which the administrator provides as input to the network incident analysis system. In other cases, a network administrator or an automated network monitoring tool could detect a problem within the network and provide a notification to the incident analysis system.

Next, the process 300 identifies (at 310) individual network entities relevant to the incident and adds these individual network entities to a new component graph. In certain cases, the network administrator will have specified these individual entities (e.g., by specifying particular VMs that are causing problems). However, in many cases, the incident analysis system receives a notification that a particular distributed application is suffering from degraded performance. In the latter case, the component graph builder begins by identifying the specific VMs or other network entities that relate to the application (e.g., by retrieving the network entities tagged as belonging to that application in the network monitoring data). For a three-tier application, this includes the front-end web servers, the application servers, and the back-end database servers. For a micro-services-based application (e.g., a Kubernetes application), this can include any of the entities on which these micro-services run (e.g., numerous Kubernetes Pods).

FIG. 4 conceptually illustrates two stages 405-410 of the building of a component graph 400 according to some embodiments. As shown, in the first stage 405 the component graph 400 only includes three unconnected nodes 415-425 for three network entities. These nodes represent three VMs belonging to an application specified as the subject of a network incident (e.g., a front-end VM and two back-end VMs).

The process 300 then begins the first iteration (of one or more iterations) adding additional network entity nodes to the component graph for the incident. The process 300 selects (at 315) an entity added to the graph during the last iteration. During the first iteration, these entities are the individual network entities identified as relevant to the incident and added to the graph at operation 310. It should be understood that the process 300 is a conceptual process. While the figure shows operations 320-355 performed serially for each entity added to the graph in the previous iteration, some embodiments perform these operations in parallel for some or all of the entities.

The process 300 then uses (at 320) monitoring data to identify all neighbors of the selected entity. In some embodiments, the neighboring entities are identified based on defined neighbor relationships. In some embodiments, a set of neighborhood relationships are defined for each type of entity that can be discovered from metadata or other information in the network monitoring data collected and stored by the incident analysis system. For instance, a VM is neighbors with any flows sent to or from that VM, any of its virtual network interface controllers (VNICs), the host on which the VM executes, virtual disks used by the VM, etc. Host computers are neighbors with the VMs that execute on the hosts, all of their physical NICs, any physical network elements directly connected to the hosts (e.g., TOR switches), etc.

It should be noted that in some embodiments the graph building process filters out neighboring entities that are (i) already in the component graph and (ii) have a relationship with the selected entity already defined in the component graph. For instance, if a host computer was added in the first iteration because it hosts an application VM that is used to start the graph building process, then that application VM is a neighboring entity of the host computer in the next iteration. However, the relationship is already defined in the graph (as described below), so there is no reason to consider this application VM as a neighboring entity for the host.

With the neighboring entities identified for the entity selected at operation 315, the process 300 selects (at 325) one of these neighboring entities to ensure that this entity is correctly added to the component graph. As discussed above for the selection of previously added entities, it should be understood that in some embodiments these neighboring entities are not individually processed in serial fashion, but rather that the component graph builder adds numerous entities to the component graph in parallel for a given previously-added entity (and across multiple previously-added entities, as noted above).

The process 300 then determines (at 330) whether the selected neighboring entity is already in the component graph. If the identified neighboring entity is not already part of the component graph, the process 300 adds (at 335) the neighboring entity to the graph. A neighboring entity of one entity will often already be part of the component graph in the case of groups of inter-related entities, especially in later iterations of the graph building process. For instance, both the VNIC associated with a VM and the host computer on which that VM resides might be added in one iteration, and then a second iteration would evaluate the host to find neighbors and identify the VNIC as a neighbor. Even in the first iteration, if two VMs belonging to an application are communicating, then a flow sent from one of the VMs to the other will be added for the first VM (with edges defined between the first VM and the flow) and thus does not need to be added for the second VM (although additional edges are defined between the second VM and the flow, as described below).

Next, the process 300 determines (at 340) whether the relationship between the selected entity and the neighboring entity is one that is specified for a unidirectional edge. If the relationship is specified for such an edge, the process 300 adds (at 345) a unidirectional edge between the selected entity and the neighbor entity. On the other hand, if the relationship is not so specified, the process 300 adds (at 350) a bidirectional edge between the selected entity and the neighbor entity.

In order to ensure that dependencies are not missed, some embodiments add bidirectional edges between neighboring entities by default. That is, without any further information, the component graph builder assumes the possibility of dependencies running in both directions (e.g., the metrics of a VM are dependent on its host and the metrics of the host are dependent on its VMs). This allows for the component graph to be built without requiring specific information about causal dependencies. In certain cases, such as for caller and callee microservices, a single direction of dependency is known based on the type of relationship, and the graph builder uses a unidirectional edge in the direction of the dependency.

The process 300 then determines (at 355) whether additional neighboring entities of the current selected entity remain to be added to the graph and/or have edges added from the selected entity. If additional neighboring entities remain, the process 300 returns to 325 to select the next neighboring entity for the currently selected entity.

Once all of the neighboring entities have been analyzed for the selected entity, the process 300 determines (at 360) whether there are any more entities added in the last iteration for which to identify neighbors in the current iteration. If additional such entities remain, the process 300 returns to 315 to select another entity added to the graph in the prior iteration, identify the neighbors of that entity, and add those neighbors to the graph.

The second stage 410 of FIG. 4 illustrates the component graph 400 after one iteration of adding entities to the graph. As shown, for each of the nodes 415-42 representing application VMs, nodes representing the vNICs of those VMs and the host computers on which the VMs reside have been added to the graph. In addition, nodes representing flows between the VMs as well as to the first VM have been added. It should be understood that a common component graph will include nodes representing many other types of entities (e.g., virtual disks, virtual switches and routers, etc.).

Once the current iteration of graph building is complete (i.e., neighboring entities have been identified and added for all of the entities added in the previous iteration), the process 300 determines (at 365) whether to continue building the graph or if the component graph is complete. If the graph building is to be continued, the process 300 proceeds (at 370) to a next iteration and returns to 315. Because the iteration has advanced, the entities added in the previous iteration as neighboring entities are now eligible for selection at 315. On the other hand, if the graph building process is complete, the process 300 ends.

Some embodiments use a predefined number of iterations to build the component graph for a network incident. The number of network entities can grow very quickly (e.g., a host computer might host hundreds of VMs, a VM could have numerous incoming and/or outgoing flows, etc.), so the number of iterations may be small (e.g., 3 or 4). Even with only a few iterations, the number of entities in a component graph can quickly reach the thousands. Other embodiments, rather than using a predefined number of iterations, stop the graph building process after a threshold number of entities in the graph has been reached.

FIG. 5 conceptually illustrates a portion of a network 500 and a (portion of a) component graph 550 for a network incident that occurs in the network portion 500. As shown, in the network 500 a set of VMs 505-520 (as well as other VMs) execute on a set of host computers 525-540, all of which are connected to the same TOR switch 545. A source VM 505 communicates with the front-end VM 510 for an application through a first large data flow. This causes the front end VM 510 to send large flows to the back-end VMs 515 and 520, thereby causing a slow-down at these VMs. This slow-down may manifest as a slow response time, high CPU and/or memory usage at the VM, etc.

The component graph portion 550 shows edges between the nodes representing each of these VMs and their host computers and vNICs. Each of the host computer nodes connects to the node for the TOR switch, as well as numerous other nodes that are not shown for simplicity (e.g., other VMs, etc.). In addition, nodes for the flows are shown in the component graph, and the front-end VM receives other flows that are not shown in the illustration of the network 500. Each of the edges in this case is a bidirectional edge. Although the connections between nodes for the flows are shown using arrows, this is meant to display the direction of the flow. In some embodiments, the edges for the flows are also bidirectional, as the dependencies can run in both directions. It should be understood that the number and types of entities shown here is limited for simplicity, and many other types of entities could exist in a typical incident component graph.

As described above with respect to FIG. 1, in addition to building the component graph, the network incident analysis system of some embodiments identifies problematic symptoms of the relevant network entities. In some embodiments, this is handled as part of the specification of the network incident, with the network administrator identifying one or more metrics of one or more network entities as the incident or indicative of the incident. In other embodiments, the network incident relates to an application or other entity, and the network incident analysis system analyzes any network entities identified as relevant to the incident for problematic symptoms.

For each problematic symptom, the network incident analysis of some embodiments uses probabilistic analysis based on the component graph for the incident to identify one or more potential root causes of the incident. The network incident analysis system analyzes at least a set of the network entities in the component graph using probabilistic analysis to determine whether adjusting metrics of a given network entity tends to affect the problematic network entity metrics that are diagnosed as indicative of the network incident. If adjustment of the network entity's metrics is determined to affect the problematic entity metrics (and the network entity's metrics themselves at least somewhat deviate from their norm), some embodiments identify that network entity as a potential root cause.

FIG. 6 conceptually illustrates a process 600 of some embodiments for identifying and ranking root causes for a set of problematic symptoms. The process 600, in some embodiments, is performed by a module or a set of modules of a network incident analysis system. For instance, in some embodiments, the root cause identifier 115 shown in FIG. 1 includes a model building module as well as a probabilistic root cause analysis module that uses the models built by the model building module.

As shown, the process 600 begins by retrieving (at 605) recent time-series metric data for the entities in the component graph. In some embodiments, this metric data is retrieved for each of the entities in the component graph. Different embodiments use different time periods for which to retrieve the metric data (e.g., data from the prior day, prior week or two weeks, prior month, etc.). Some embodiments also use only a subset of the samples of this metric data. For example, the stored metric data might include values for each metric measured every 5 minutes, but this may be more data than is needed (and can lead to overfitting). Thus, in this case, some embodiments might only use the metric values from every half hour or another time period.

Next, the process 600 uses (at 610) the metric data to train a model for relationships between the metrics of neighboring entities in the component graph (i.e., a model specifying how the metrics of one entity depend on its neighboring entities, and vice versa). Some embodiments use a Markov Random Field (MRF) framework for this model (and the subsequent analysis). Specifically, the network incident analysis system builds a model of the distribution of metrics for all of the entities in the component graph as an MRF. This distribution is defined as a product of individual network entity factors. A function is defined that, for each entity, takes as input the values of the metrics of that entity's incoming neighbors in the directed component graph (i.e., neighbors on which the entity is dependent) and outputs a probability score between 0 and 1.

More specifically, the root cause identifier models the distribution of metrics for all entities as an MRF. This distribution will be referred to herein as P_{G}, and is based on a general directed component graph that has the potential for directed cycles. The distribution P_{G} is defined as a product of individual entity factors Pᵥ, for each entity v:

$${P}_{G} = \frac{1}{Z} {\prod }_{v : V ( G )} {P}_{v} ( v \vert in\_nbrs ( v ) )$$

In this equation, V(G) denotes the entities in the component graph G, in_nbrs(v) denotes the set of neighboring entities with an incoming edge to entity v in the component graph, and Z is a normalizing constant. Pᵥ is a function that takes as input the values of metrics of v and the values of metrics of the incoming neighbors of v (in_nbrs(v)) and outputs a probability score between 0 and 1. The distribution P_{G} thus is a product of these probability scores for each entity v divided by the normalizing constant.

As the relationship between the metrics of one entity and those of its neighboring entities can be complex and variable across entities, training the model entails determining the function Pᵥ by relating metrics of each entity v in a time slice to the metrics of its neighbors in the same time slice (i.e., the time slice for which the metric data was retrieved). In some embodiments, the root cause identifier fits a multivariate distribution for Pᵥ, for each v, using a standard model such as a linear regression with normal error, ridge regression (a form of robust linear regression), a Gaussian mixture model (GMM), a neural network, or a support vector machine. Some embodiments use the same model for all network incidents, whereas other embodiments use different models for different environments. Some embodiments determine the correct choice of model by analyzing training errors in learning P, across multiple entities.

It should be noted that, like the component graphs, the models are not stored but rather are trained on-demand for each network incident. This ensures that the model is trained for the specific network topology and environment, which changes regularly, so that a model trained for an outdated application topology is not used. Furthermore, the on-demand training ensures that the metric data used for the training is recent and from times relevant to the actual incident. This is especially important as an incident often involves a novel pattern of metric values that has not previously occurred. In addition, per-incident training of the models avoids the need to store numerous entity models, thereby saving memory. Some embodiments train the model for each P, using the metric data from the recent time period. Because an arbitrary large number of features can cause overfitting, some embodiments only use a subset of the neighbor metrics (e.g., 5, 10, 20) based on their correlation with the metrics of the entity v.

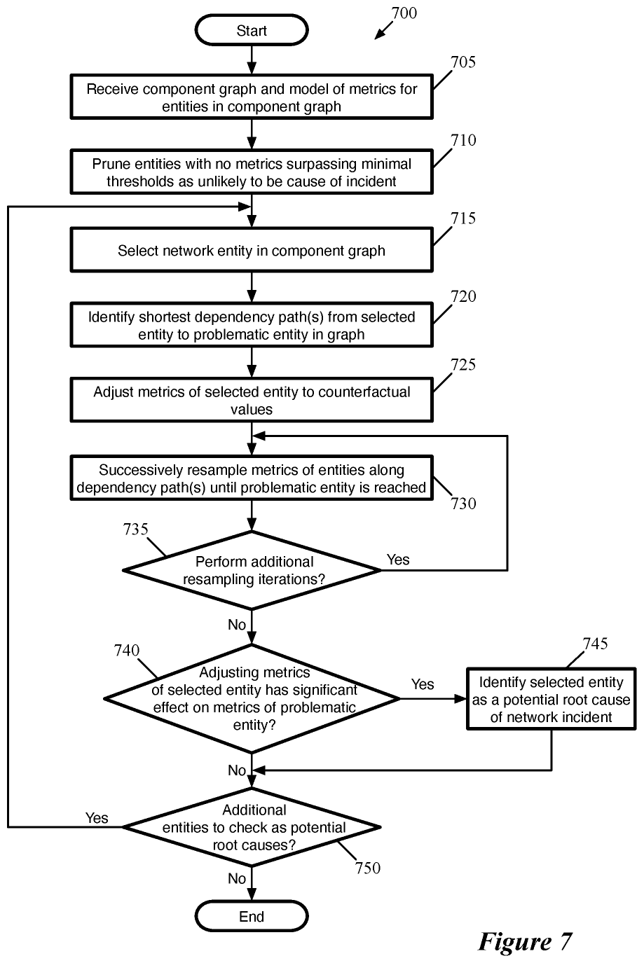

With the model built, the process 600 uses (at 615) probabilistic analysis to identify potential root causes of the incident based on the trained model. In some embodiments, as described in more detail below by reference to FIG. 7, the root cause identifier uses the model to adjust metrics of various different selected entities that are one or more hops away from a problematic entity (i.e., an entity relevant to the incident with problematic metric values) in a dependency chain (as determined by the component graph) and determine whether the adjustments have an effect on the problematic entity (i.e., on the problematic metric values of that entity).

Once the potential root causes for the incident have been identified, the process 600 ranks (at 620) these root causes from most likely to least likely. Some embodiments rank the identified network entities as root causes based on how anomalous their metrics are. The level of anomaly for a given entity is measured based on the number of standard deviations of its metrics from their historical mean value in some embodiments. Different embodiments use the worst-case metric for each entity or the average level of abnormality for the different metrics of each entity to determine this ranking.

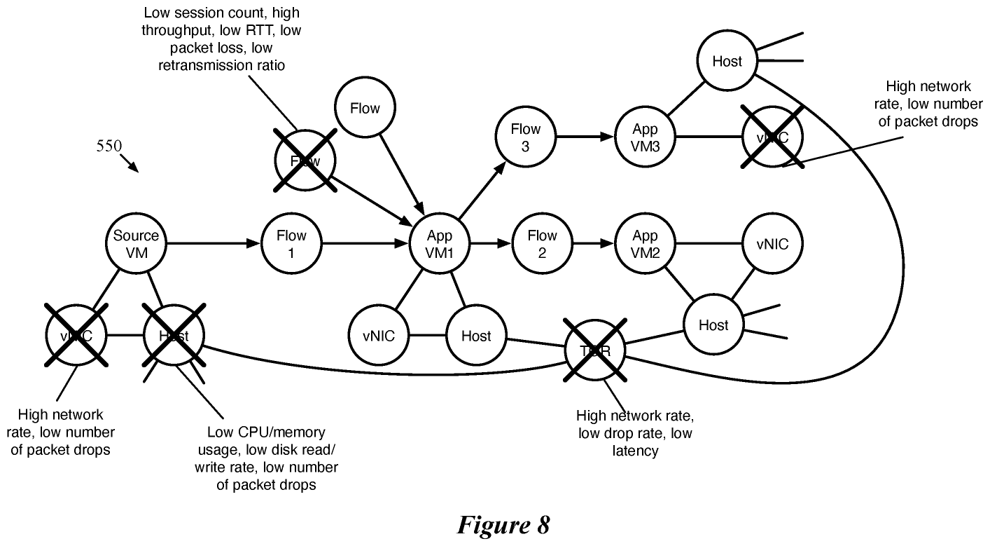

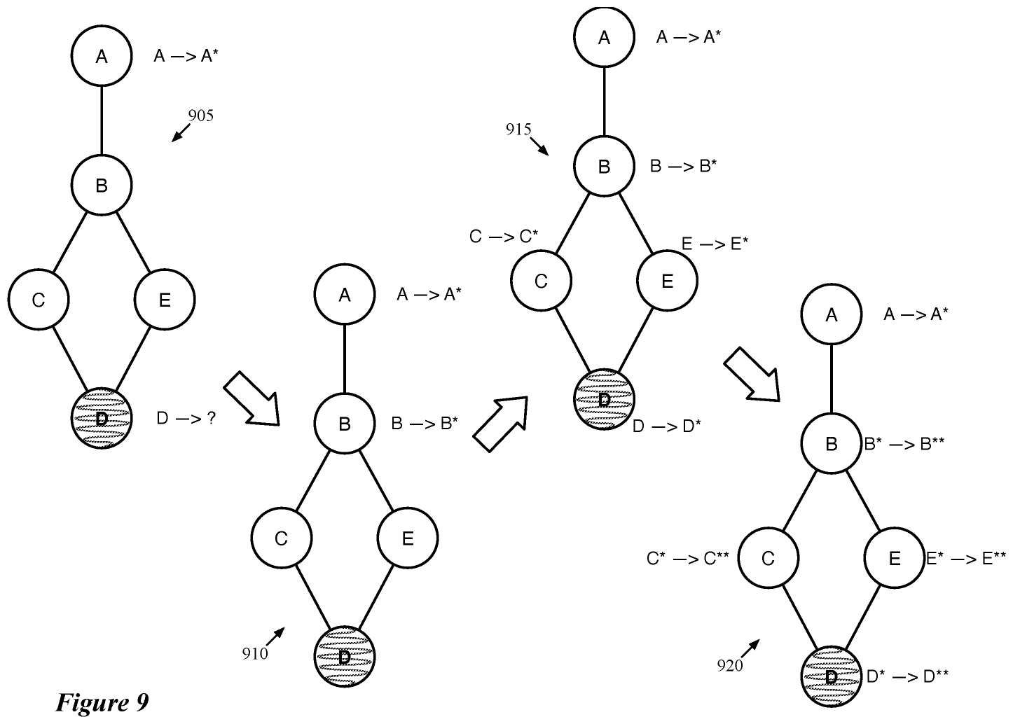

FIG. 7 conceptually illustrates a process 700 for identifying the potential root causes for a given problematic entity. In some embodiments, the root cause identifier of the incident analysis system performs the process 700 for each identified problematic entity. For instance, if multiple VMs associated with an application are identified as having metrics indicating a problem, the process 700 (or a similar process) is performed for each of these VMs. The process 700 will be described by reference to FIGS. 8 and 9 which illustrate the pruning of a component graph and an example of the sampling process used to identify whether a network entity is a likely root cause of a problematic entity.

As shown, the process 700 begins by receiving (at 705) a component graph and a model of the metrics for the network entities in the component graph. In some embodiments, the component graph is generated specifically for the network incident according to the process 300. Similarly, in some embodiments, the model specifying how the metrics of the various entities in the graph are inter-related is generated for the network incident according to the process described above by reference to FIG. 6.

Next, the process 700 prunes (at 710) entities in the graph that do not have any metrics surpassing minimal thresholds on the basis that these entities are unlikely to be a root cause of the network incident. It should be noted that this does not entail removing these entities from the component graph, as that would break dependency chains and affect the model. Rather, these entities are removed from being selected in the subsequent operation 715 and analyzed as a potential root cause. In other embodiments, the pruning is performed as the network entities are selected. That is, the operation shown in 715 is performed to select a network entity and then the process determines whether to perform the remainder of operations 720-745 for the entity or whether the metrics for the entity are such that the analysis can be skipped for that entity. It should also be understood that the process 700 is a conceptual process. While the figure shows operations 720-745 performed serially for each entity in the component graph, some embodiments perform these operations in parallel for some or all of the entities.

In some embodiments, the threshold metric values for pruning out entities is significantly lower than the threshold used for identifying problematic entities. Some embodiments only prune entities with metric values that are all a specified number of standard deviations below (or above, if smaller values for a metric are problematic) the average values for the metrics. Other embodiments use absolute thresholds for each metric (e.g., 5% CPU and/or memory usage) and only prune entities that meet these thresholds for all of their metrics.

FIG. 8 conceptually illustrates the pruning of nodes for certain network entities from the analysis of the component graph 550 shown in FIG. 5. Of the nodes shown in the illustrated portion of the graph, nodes for two vNICs, a host, a TOR switch, and one flow are removed. In this case, all of these network entities have very good metric values (i.e., below/above the specified thresholds) indicating that they are unlikely to be causing the network incident. The flow has a low session count, high throughput, low round trip time, low packet loss, and a low retransmission ratio. The vNICs each have a high network rate and a low number of packet drops while the TOR switch has a high network rate, a low drop rate, and low latency. The VM that can be pruned has a low CPU and memory usage, a low disk read/write rate, and a low number of packet drops. As there may be thousands of individual network entities in the component graph for a network incident, removing a segment of these entities from consideration can provide significant resource savings for the incident analysis system.

The process 700 then analyzes each of the (non-pruned) network entities in the component graph to determine whether that entity is a likely root cause. As shown, the process 700 selects (at 715) one of the network entities in the component graph. Some embodiments select these network entities in breadth-first order starting from the problematic network entity (so that the initially-selected network entities are direct neighbors of the problematic network entity in the component graph that are not pruned out due to their metric values). Other embodiments select the network entities randomly or in a different order.

Next, the process 700 identifies (at 720) the shortest dependency path(s) from the selected entity to the problematic entity in the component graph. Because most edges in the component graph are bidirectional, this is typically the shortest path through the graph. However, if unidirectional edges are involved, then the path through the graph is required to follow a chain of dependencies (e.g., a callee microservice entity cannot reach through the problematic entity directly through the directed edge from the corresponding caller microservice entity). In addition, if there are multiple overlapping equal-length dependency chains, some embodiments analyze the entities of these dependency chains in a single pass.

FIG. 9 conceptually illustrates the analysis process to determine whether a selected entity is a likely root cause over four stages 905-920. Each of these stages 905-920 shows a dependency chain from entity A to entity D, in which entity D is the problematic entity and entity A is the selected entity that is being evaluated. In this example, the path from entity A to entity D branches. The metrics of B are dependent on the metrics of A, the metrics of both C and E are dependent on the metrics of B, and the metrics of the problematic entity D are dependent on the metrics of both C and E.

The root cause identifier can then perform the analysis to determine whether the metrics of the selected entity have a significant effect on the metrics of the problematic entity, using a counterfactual technique. Generally, for a selected entity A and problematic entity D, this technique adjusts the values of the selected entity's metrics to counterfactual values (A′) and samples the values of the problematic entity's metrics via the distribution P_{G}(D|A′, ξ) where ξ is the value of the metrics for all of the entities other than A and D. If the new metrics D′ are changed substantially, then the root cause identifier concludes that the selected entity A is a likely root cause of the problematic metrics at entity D. Because the problematic entity D and the selected entity A are not necessarily neighbors, the sampling process to adjust the metrics of D occurs in steps in some embodiments. As described below, some embodiments use an approximated Gibbs sampling to iteratively sample metric values for the other entities.

As shown, the process 700 adjusts (at 725) the metrics of the selected entity to counterfactual values. It should be noted that, while the training for the model of the distribution P_{G} is performed using metric values from a recent time period (e.g., the past week), the counterfactual values are adjusted from the most current metric values (i.e., those occurring at the time of the network incident). Some embodiments adjust all of the metrics of the selected entity, while other embodiments only adjust the metrics that exceed (or fall below) the conservative thresholds used for pruning entities from consideration.

In some embodiments, the metrics of the selected entity are adjusted to values that are a set number of standard deviations (e.g., 2, 3, etc.) away from their current value, moving towards a more optimal value for the metric. For instance, if the selected entity has somewhat high CPU usage, then the counterfactual adjustment for that metric would lower the CPU usage value. In the first stage 905 of FIG. 9, the metrics for the selected entity are adjusted from A to A*, with the goal of identifying how the metrics of the problematic entity D will be changed.

Next, the process 700 successively resamples (at 730) the metrics of the entities along the dependency path(s) to the problematic entity until the problematic entity is reached and its metrics are resampled. Some embodiments resample these entities in breadth-first order along the dependency path. For each entity v in the dependency path, the process resamples the metrics of v from Pᵥ(v|in_nbrs(v)) until the problematic entity is reached.

The second stage 910 of FIG. 9 shows that the metrics for entity B are adjusted from B to B*, resampling based on the adjusted metrics A*. Next, in the third stage 915, the metrics for entities C and E are adjusted from C to C* and from E to E*, respectively, based on the resampled metrics B*. Subsequently, the metrics for entity D are adjusted from D to D*, based on the resampled metrics C* and E*.

Returning to FIG. 7, the process 700 then determines (at 735) whether to perform additional resampling iterations. If additional sampling iterations are needed, the process returns to 730 and again successively resamples the metrics of the entities along the dependency path. Some embodiments resample the entities in the opposite direction (assuming all of the connections are bidirectional edges representing cyclic dependencies).

Because of the likelihood of cyclic dependencies in the model (due to the cyclic dependencies in the component graph), some embodiments perform multiple iterations of resampling. For instance, in the example shown in FIG. 9, the metrics of entity D depend on the metrics of entity C, but the metrics of C might also depend on D. Thus, after D is resampled once, C should again be resampled (and any changes propagated back to entity D and through to entities B and A, and so on). This is shown in the fourth stage 920, which illustrates that the metrics for entities B, C, E, and D have again been resampled to arrive at, respectively, metric values B**, C**, E**, and D**.

Some embodiments perform a prespecified number of iterations of resampling (e.g., 3, 4, 6, etc.), and thus the determination as to whether to perform additional resampling iterations is determined solely by the number of iterations already performed. Other embodiments resample until the cyclic dependencies have been accounted for enough for the resampled metric values to stabilize. In this case, some embodiments stop performing additional resampling iterations once the change in the metric values from one iteration to the next is below a threshold (e.g., a threshold percentage change).

Once these iterations through the resampling process are complete, the process 700 determines (at 740) whether adjusting the metrics of the selected entity has a significant effect on the metrics of the problematic entity. For instance, if the problematic entity is a VM with high CPU utilization and the final resampled value for the VM has much lower CPU utilization based on improving the metrics of the selected entity, then the metrics of the selected entity are at the very least correlated with those of the problematic entity.

Some embodiments make this determination by comparing the adjusted values of the problematic entity's metrics to the actual current (problematic) values of those metrics. Other embodiments, however, perform the same resampling process starting with the unadjusted values of the metrics for the selected entity and compare the resulting metric values for the problematic entity to those arrived at by adjusting the metrics of the selected entity. For the comparison, some embodiments use a T-test and determine whether the difference is large enough (e.g., if the t-value is greater than a threshold). It should be noted that, in some embodiments, the resampling process is actually performed numerous times (e.g., several hundred or even several thousand times) for both the adjusted (counterfactual) and actual metric values of the selected entity so that the average (mean) of the adjustments to the problematic entity as well as the pooled error in the T-test calculation are meaningful (a single resampling could lead to extreme outlier values in some cases).

If the adjustment to the metrics of the selected entity is determined to have a significant effect on the metrics of the problematic entity, then the process identifies (at 745) the selected entity as a potential root cause of the network incident. It should be noted that the statistical analysis does not prove that this is a root cause but rather identifies that there is a correlation between the at least partially sub-optimal metrics of the selected entity and the metrics of the problematic entity and thus that the selected entity is a potential root cause with a decent likelihood of actually being a cause of the network incident.

Next, the process 700 determines (at 750) whether additional entities remain to be checked as potential root causes. As noted, for each problematic entity, the process 700 selects each other entity in the component graph (except those that are pruned at operation 710 because all of their metrics are optimal) to determine whether that entity is a potential root cause of the network incident. If additional entities remain to be checked, the process 700 returns to 715 to select the next network entity in the component graph (e.g., in a breadth-first manner) and perform the resampling and comparison analysis for this next entity. Once all of the entities have been checked, the process 700 ends.

Once a set of potential root causes of a network incident have been identified (whether using a resampling process such as that shown in FIG. 7 or via another method), some embodiments generate human-interpretable explanations as to how each potential root cause may have caused the network incident. Some embodiments assign labels to entities based on their current metric values and then use a state machine that defines transitions between these labels to generate the human-interpretable explanations for the potential root causes.

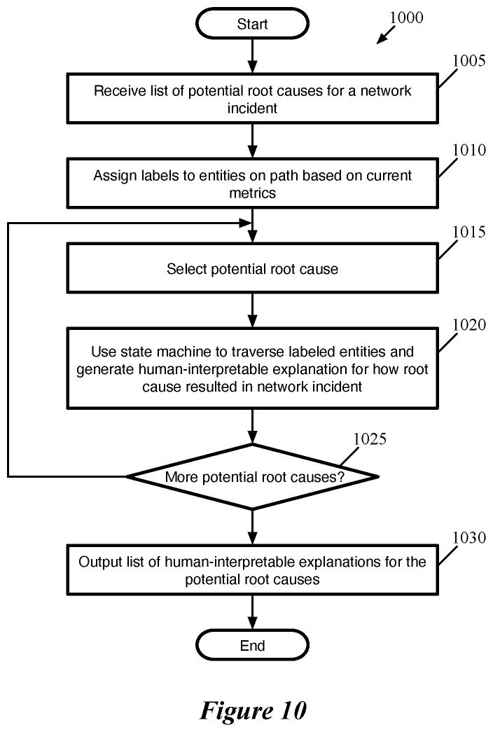

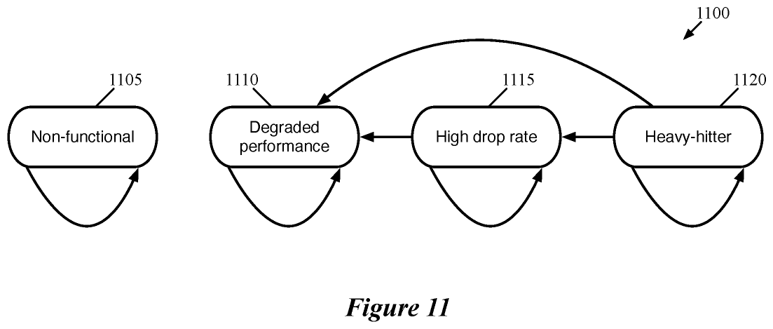

FIG. 10 conceptually illustrates a process 1000 of some embodiments for generating human-interpretable explanations for a set of root causes. In some embodiments, the process 1000 is performed by a network incident analysis system (e.g., by the explanation generator 120 of the network incident analysis system 100 shown in FIG. 1). The process 1000 will be described at least in part by reference to FIG. 11, which illustrates an example state machine showing transitions between entity labels used to generate explanations for root causes.

As shown, the process 1000 begins by receiving (at 1005) a list of potential root causes for a network incident. As noted, in some embodiments these root causes are generated by a process such as that described above, using model training and resampling based on the metrics of the various entities in the network). In other embodiments, the root causes can be generated by other techniques different than those described herein, so long as a chain of dependencies and a set of metrics for each entity in the chain can be determined.

Next, the process 1000 assigns (at 1010) labels to entities in the component graph based on the current metrics. Examples of these labels in some embodiments can include non-functional, degraded performance, high drop rate, large data flow (or heavy hitter), and properly functional (or okay). The non-functional label is assigned to entities that have metrics so far above or below optimal that the entity is effectively no longer functioning or to entities that are not functioning at all (e.g., VMs that cannot communicate externally or otherwise are not functioning in one or more respects). The degraded performance label, in some embodiments, is assigned to entities that have one or more metrics above/below a threshold for identifying a problematic entity such that the performance of the entity is likely to be degraded or the metric is indicative of performance degradation. For instance, a VM or host with high memory and/or CPU utilization, low throughput, high latency, etc. could be labeled as having degraded performance. Some embodiments use the high drop rate label for both data message flows with a high drop rate as well as network elements, NICs, etc. that drop packets at a high rate. The large data flow (heavy hitter) label is used for data message flows that exceed a particular packet rate or data transfer rate. It should be understood that these are simply examples of a set of labels that could be used and that some embodiments use more coarse-grained or fine-grained labels (e.g., using different labels for entities with different metrics exceeding thresholds).

Next, the process 1000 selects (at 1015) a potential root cause. It should be understood that the process 1000 is a conceptual process. While the figure shows operation 1020 performed serially for each entity listed as a potential root cause, some embodiments perform the operation in parallel for some or all of the potential root causes.

The process 1000 then uses (at 1020) a state machine to traverse the labeled entities from the selected potential root cause entity to the problematic entity and generate a human-interpretable explanation for how the root cause resulted in the network incident. In some embodiments, the state machine encodes causal truths regarding types of entities having particular labels. Examples of these causality rules are “large data flow can cause high drop rate on a vNIC”, “large data flow can cause high load on a VM”, “degraded performance (or more specifically, high CPU and/or memory usage) of a host can cause degraded performance (or more specifically, high CPU and/or memory usage) of a VM executing on that host”, etc.

FIG. 11 conceptually illustrates examples of a state machine 1100 using the coarse-grained labels described above. In this case, the state machine 1100 has four nodes 1105-1120 (respectively for the label-states non-functional, degraded performance, high drop rate, and heavy-hitter). It should be understood that more complex state machines are possible for embodiments that have more specific labels. For instance, in some embodiments, the state machines used for generating explanations have states that are specific to the combination of label and entity type (e.g., a degraded performance host is a separate state from a degraded performance VM). In addition, the state machines of some embodiments have states using more specific labels based on the specific metrics that are exceeding thresholds (e.g., a VM with degraded performance due to high CPU usage is a different state than a VM with degraded performance due to a high memory usage or a heavy hitter data flow is a different state than a smaller data flow with a high drop rate).

The causality chains shown in this example state machine include that (i) a heavy-hitter flow can cause another heavy-hitter flow, an entity (vNIC, VM, switch interface, etc.) to have a high drop rate, or an entity (VM, host, etc.) to have degraded performance, (ii) an entity with a high drop rate can cause another entity to have a high drop rate (e.g., a vNIC or switch interface with a high drop rate can cause many data messages of a flow to be dropped) or the degraded performance of another entity (e.g., a vNIC dropping many data messages can result in a VM having degraded performance because that VM does not respond to enough of these data messages), and (iii) one entity with degraded performance can cause another entity to have degraded performance (e.g., high CPU utilization by a VM resulting in high CPU usage by its host). In addition, one non-functional entity (e.g., a host) can result in another non-functional entity (e.g., the VMs on that host).

The process 1000 traces a path through the entities in the component graph such that each edge in the path respects the label causality rules specified in the state machine. For instance, in the example shown in FIG. 5, the source VM sends a heavy-hitter flow (Flow 1) to the front-end application VM (VM1), which as a result sends heavy-hitter flows (Flow 2 and Flow 3) to the back-end application VMs (VM2 and VM3), causing high CPU usage at the back-end application VMs. Some embodiments allow the path to skip entities that are not themselves problematic, so long as there is a direct flow that includes the entities. For instance, the front-end VM in the example might itself be labeled as functional because it does not have any problematic metric values. However, the first heavy-hitter flow (Flow 1) is causing the second and third heavy-hitter flows (Flow 2 and Flow 3), so the explanation generated by the state machine for the problematic entity VM2 is that “The heavy-hitter flow from the source VM to the application VM1 causes the heavy-hitter flow from the application VM1 to VM2, thereby causing the high CPU usage at VM2”. This alerts the administrative team to pinpoint the behavior of the source VM as a possible root cause of the network incident and more quickly resolve the problem.

After the explanation has been generated for the currently-selected root cause has resulted in the network incident, the process 1000 determines (at 1025) whether additional potential root causes remain to analyze. Some embodiments analyze all of the potential root causes identified by the incident analysis system, while other embodiments only analyze the highest-ranked potential root causes (e.g., the top 5 or 10 as determined by the ranking described above). If additional root causes remain to be analyzed, the process 1000 returns to 1015 to select another of the potential root causes.

Once explanations have been generated for all of the potential root causes, the process 1000 outputs (at 1030) the list of human-interpretable explanations for the potential root causes. In different embodiments, this information may be output through a graphical user interface, a command-line interface, etc., so that the user (e.g., a network administrator) can review the potential root causes and attempt to solve the problem in the network.

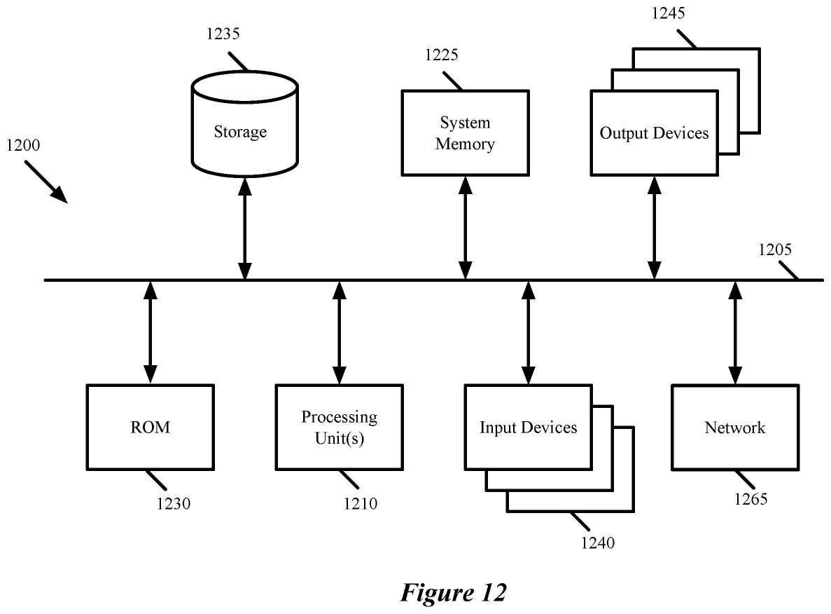

FIG. 12 conceptually illustrates an electronic system 1200 with which some embodiments of the invention are implemented. The electronic system 1200 may be a computer (e.g., a desktop computer, personal computer, tablet computer, server computer, mainframe, a blade computer etc.), phone, PDA, or any other sort of electronic device. Such an electronic system includes various types of computer readable media and interfaces for various other types of computer readable media. Electronic system 1200 includes a bus 1205, processing unit(s) 1210, a system memory 1225, a read-only memory 1230, a permanent storage device 1235, input devices 1240, and output devices 1245.

The bus 1205 collectively represents all system, peripheral, and chipset buses that communicatively connect the numerous internal devices of the electronic system 1200. For instance, the bus 1205 communicatively connects the processing unit(s) 1210 with the read-only memory 1230, the system memory 1225, and the permanent storage device 1235.

From these various memory units, the processing unit(s) 1210 retrieve instructions to execute and data to process in order to execute the processes of the invention. The processing unit(s) may be a single processor or a multi-core processor in different embodiments.

The read-only-memory (ROM) 1230 stores static data and instructions that are needed by the processing unit(s) 1210 and other modules of the electronic system. The permanent storage device 1235, on the other hand, is a read-and-write memory device. This device is a non-volatile memory unit that stores instructions and data even when the electronic system 1200 is off. Some embodiments of the invention use a mass-storage device (such as a magnetic or optical disk and its corresponding disk drive) as the permanent storage device 1235.

Other embodiments use a removable storage device (such as a floppy disk, flash drive, etc.) as the permanent storage device. Like the permanent storage device 1235, the system memory 1225 is a read-and-write memory device. However, unlike storage device 1235, the system memory is a volatile read-and-write memory, such a random-access memory. The system memory stores some of the instructions and data that the processor needs at runtime. In some embodiments, the invention's processes are stored in the system memory 1225, the permanent storage device 1235, and/or the read-only memory 1230. From these various memory units, the processing unit(s) 1210 retrieve instructions to execute and data to process in order to execute the processes of some embodiments.

The bus 1205 also connects to the input and output devices 1240 and 1245. The input devices enable the user to communicate information and select commands to the electronic system. The input devices 1240 include alphanumeric keyboards and pointing devices (also called “cursor control devices”). The output devices 1245 display images generated by the electronic system. The output devices include printers and display devices, such as cathode ray tubes (CRT) or liquid crystal displays (LCD). Some embodiments include devices such as a touchscreen that function as both input and output devices.

Finally, as shown in FIG. 12, bus 1205 also couples electronic system 1200 to a network 1265 through a network adapter (not shown). In this manner, the computer can be a part of a network of computers (such as a local area network (“LAN”), a wide area network (“WAN”), or an Intranet, or a network of networks, such as the Internet. Any or all components of electronic system 1200 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

This specification refers throughout to computational and network environments that include virtual machines (VMs). However, virtual machines are merely one example of data compute nodes (DCNs) or data compute end nodes, also referred to as addressable nodes. DCNs may include non-virtualized physical hosts, virtual machines, containers that run on top of a host operating system without the need for a hypervisor or separate operating system, and hypervisor kernel network interface modules.

VMs, in some embodiments, operate with their own guest operating systems on a host using resources of the host virtualized by virtualization software (e.g., a hypervisor, virtual machine monitor, etc.). The tenant (i.e., the owner of the VM) can choose which applications to operate on top of the guest operating system. Some containers, on the other hand, are constructs that run on top of a host operating system without the need for a hypervisor or separate guest operating system. In some embodiments, the host operating system uses name spaces to isolate the containers from each other and therefore provides operating-system level segregation of the different groups of applications that operate within different containers. This segregation is akin to the VM segregation that is offered in hypervisor-virtualized environments that virtualize system hardware, and thus can be viewed as a form of virtualization that isolates different groups of applications that operate in different containers. Such containers are more lightweight than VMs.

Hypervisor kernel network interface modules, in some embodiments, is a non-VM DCN that includes a network stack with a hypervisor kernel network interface and receive/transmit threads. One example of a hypervisor kernel network interface module is the vmknic module that is part of the ESXi™ hypervisor of VMware, Inc.

It should be understood that while the specification refers to VMs, the examples given could be any type of DCNs, including physical hosts, VMs, non-VM containers, and hypervisor kernel network interface modules. In fact, the example networks could include combinations of different types of DCNs in some embodiments.

While the invention has been described with reference to numerous specific details, one of ordinary skill in the art will recognize that the invention can be embodied in other specific forms without departing from the spirit of the invention. In addition, a number of the figures (including FIGS. 3, 6, 7, and 10) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

1. A method for evaluating incidents within a network:
receiving notification of (i) a first incident related to a first network entity and (ii) a second incident related to a second network entity;
in response to the notification of the first incident, using network monitoring data to generate a first component graph of a first portion of the network that includes the first network entity, the first component graph comprising a first plurality of network entities related to the first network entity according to the network monitoring data;
in response to the notification of the second incident, using network monitoring data to generate a second component graph of a second portion of the network that includes the second network entity, the second component graph comprising a second plurality of network entities related to the second network entity according to the network monitoring data; and
using the first and second component graphs to respectively identify root causes of the first and second incidents.

2. The method of claim 1 further comprising:
generating a separate component graph of a different portion of the network for each incident of a plurality of incidents within the network; and
using the respective component graphs to respectively identify root causes for each of the incidents within the network.

3. The method of claim 2, wherein the component graphs are not saved after the potential root causes are identified in order to save memory.

4. The method of claim 1, wherein the first and second network entities are respectively first and second applications implemented in the network.

5. The method of claim 4, wherein the network entities in the first and second component graphs comprise at least virtual machines (VMs), hosts, physical forwarding elements, network interface controllers, and data flows.

6. The method of claim 4, wherein:
the network entities are represented as nodes in the component graphs; and
the first component graph comprises multiple nodes to represent the first application.

7. The method of claim 6, wherein:
the first application is implemented by a plurality of machines; and
each of the machines of the first application is represented by a separate node in the first component graph.

8. The method of claim 1, wherein:
the network entities are represented as nodes in the component graphs; and
connections between the nodes in the component graphs are determined based on (i) network monitoring data indicating current conditions in the network and (ii) definitions specifying relationships between types of network entities.

9. The method of claim 8, wherein generating the first component graph comprises:
identifying one or more nodes representing the first network entity and adding the identified nodes to the first component graph; and
for each node representing the first network entity:
determining connections between the node and additional nodes representing other network entities; and
adding the additional nodes with connections to the node representing the network entity to the first component graph.

10. The method of claim 9, wherein generating the first component graph further comprises, for at least one additional iteration:
for each respective node added to the first component graph in a previous iteration:
determining connections between the respective node and respective additional nodes representing other network entities; and
adding the respective additional nodes with connections to the respective node to the first component graph.

11. The method of claim 1, wherein the first and second component graphs each comprise cyclic dependencies.

12. The method of claim 1, wherein the first and second component graphs comprise at least one network entity in common.

13. The method of claim 1, wherein the first and second component graphs represent different portions of the network with no entities in common.

14. A non-transitory machine-readable medium storing a program which when executed by at least one processing unit evaluates incidents within a network:
receiving notification of (i) a first incident related to a first network entity and (ii) a second incident related to a second network entity;
in response to the notification of the first incident, using network monitoring data to generate a first component graph of a first portion of the network that includes the first network entity, the first component graph comprising a first plurality of network entities related to the first network entity according to the network monitoring data;
in response to the notification of the second incident, using network monitoring data to generate a second component graph of a second portion of the network that includes the second network entity, the second component graph comprising a second plurality of network entities related to the second network entity according to the network monitoring data; and
using the first and second component graphs to respectively identify root causes of the first and second incidents.

15. The non-transitory machine-readable medium of claim 14, wherein the program further comprises sets of instructions for:
generating a separate component graph of a different portion of the network for each incident of a plurality of incidents within the network; and
using the respective component graphs to respectively identify root causes for each of the incidents within the network,
wherein the component graphs are not saved after the potential root causes are identified in order to save memory.

16. The non-transitory machine-readable medium of claim 14, wherein:
the first and second network entities are respectively first and second applications implemented in the network;
the network entities are represented as nodes in the component graphs; and
the first component graph comprises multiple nodes to represent the first application.

17. The non-transitory machine-readable medium of claim 16, wherein:
the first application is implemented by a plurality of machines; and
each of the machines of the first application is represented by a separate node in the first component graph.

18. The non-transitory machine-readable medium of claim 1, wherein:
the network entities are represented as nodes in the component graphs; and
connections between the nodes in the component graphs are determined based on (i) network monitoring data indicating current conditions in the network and (ii) definitions specifying relationships between types of network entities.

19. The non-transitory machine-readable medium of claim 18, wherein the set of instructions for generating the first component graph comprises sets of instructions for:
identifying one or more nodes representing the first network entity and adding the identified nodes to the first component graph; and
for each node representing the first network entity:
determining connections between the node and additional nodes representing other network entities; and
adding the additional nodes with connections to the node representing the network entity to the first component graph.

20. The non-transitory machine-readable medium of claim 19, wherein the set of instructions for generating the first component graph further comprises sset of instructions for, for at least one additional iteration:
for each respective node added to the first component graph in a previous iteration:
determining connections between the respective node and respective additional nodes representing other network entities; and
adding the respective additional nodes with connections to the respective node to the first component graph.
